(19) United States
(12) Patent Application Publication
(10) Pub. No.: US 2021/0004840 A1
(43) Pub. Date: Jan. 7, 2021

(54) PRODUCT HAVING DUAL LAYER IDENTIFICATION CODES, PRODUCT TRACEABILITY AND ANTI-COUNTERFEIT AUTHENTICATION METHOD AND APPARATUS

(71) Applicant: BEIJING ANXUNBEN TECHNOLOGY CO., LTD, Beijing (CN)

(72) Inventors: Wai Keung CHING, Beijing (CN); Tat Kwong Simon LEUNG, Beijing (CN)

(21) Appl. No.: 16/976,477

(22) PCT Filed: Feb. 28, 2019
(86) PCT No.: PCT/CN2019/076517

§ 371 Date: Aug. 28, 2020

(30) Foreign Application Priority Data
Mar. 7, 2018 (CN) 201810187665.6

(51) Int. Cl. G06Q 30/00; G06K 19/08; G06K 19/10; G06Q 10/08; G06K 17/00

(52) U.S. Cl. CPC G06Q 30/0185; G06K 19/083; G06K 17/0022; G06Q 10/0833; G06K 19/10

(57) ABSTRACT

The present application provides a product having dual layer identification codes, a product traceability and anti-counterfeiting authentication method and apparatus. The method includes: receiving a query request sent from a user by scanning a first identification code on a product; providing basic information, a logistic state, and user scanning information of the product matching the first identification code to the user; receiving an authentication request sent from a user by scanning a second identification code on the product; and providing an anti-counterfeiting authentication result of the product matching the second identification code to the user. By the present disclosure, the anti-counterfeiting effect can be guaranteed on a basis of reducing a difficulty in user query.

### CROSS REFERENCES TO RELATED APPLICATION

This patent application is a National Stage of International Application No. PCT/CN 2019/076517, filed on Feb. 28, 2019, which claims priority to Chinese patent application 201810187665.6, filed on Mar. 7, 2018, entitled “Product Having Dual Layer Identification Codes, Product Traceability and Anti-counterfeiting Authentication Method and Apparatus”, both of which are hereby incorporated by reference in their entireties.

### FIELD

The present disclosure relates to the field of anti-counterfeiting technology, and more particularly to a product having dual layer identification codes, a product traceability and anti-counterfeiting authentication method and apparatus.

### BACKGROUND

At present, due to the lack of integrity in various industries, counterfeit and shoddy goods are widely distributed in various fields. In order to protect their own brands, enterprises have taken various preventive technical measures, namely anti-counterfeiting technology. Now there are various anti-counterfeiting technologies, such as a digital anti-counterfeiting technology, a texture anti-counterfeiting technology, a security thread anti-counterfeiting technology, a moisture-sensitive anti-counterfeiting technology, and the like. The existing anti-counterfeiting technologies can play an anti-counterfeiting role to some extent, but there are still some disadvantages. If the anti-counterfeiting effect is better, accordingly the counterfeiting is difficult, then it is difficult for the user to query or identify. For example, an RFID tag needs to be identified by a dedicated device. If the difficulty in the user query or identification is reduced, the corresponding difficulty of counterfeiting is also reduced, and the anti-counterfeiting effect is relatively unsatisfactory, for example, a digital printed anti-counterfeiting code.

Therefore, it is necessary to provide a new anti-counterfeiting technology to ensure the anti-counterfeiting effect on the basis of reducing the difficulty in user query.

### SUMMARY

One of technical problems addressed by the present disclosure is to provide a product having dual layer identification codes, a product traceability and anti-counterfeiting authentication method and apparatus, by which an anti-counterfeiting effect is guaranteed on a basis of reducing a difficulty in user query.

According to an embodiment in one aspect of the present disclosure, a product having dual layer identification codes is provided, the dual layer identification codes include a first identification code attached to the product and a second identification code separated from the product.

According to an embodiment in another aspect of the present disclosure, a product traceability and anti-counterfeiting authentication method is provided, which includes:

receiving a query request sent from a user by scanning the first identification code on a product;

providing basic information, a delivery status, and user scanning information of the product matching the first identification code to the user;

receiving an anti-counterfeiting authentication request sent from a user by scanning the second identification code;

providing an anti-counterfeiting authentication result of the product matching the second identification code to the user.

According to an embodiment in another aspect of the present disclosure, a product traceability and anti-counterfeiting authentication apparatus is provided, which includes:

a query request receiving unit, configured to receive a query request sent from a user by scanning a first identification code;

a matching information providing unit, configured to provide basic information, a delivery status, and user scanning information of the product matching the first identification code to the user;

an anti-counterfeiting authentication request receiving unit, configured to receive an anti-counterfeiting authentication request sent from a user by scanning a second identification code separated from the product;

an anti-counterfeiting authentication result providing unit, configured to provide an anti-counterfeiting authentication result of the product matching the second identification code to the user.

According to an embodiment in another aspect of the present disclosure, a product traceability and anti-counterfeiting authentication assist method is provided, which includes:

acquiring a first identification code on a product by a user scan;

generating and sending a query request corresponding to a first identification code;

receiving the query request and displaying basic information, a delivery status, and user scanning information of the product matching the first identification code in response to the query request;

acquiring a second identification code separated from the product by a user scan;

generating and sending an anti-counterfeiting authentication request corresponding to the second identification code; and

receiving the anti-counterfeiting authentication request and di splaying an anti-counterfeiting authentication result of the product matching the second identification code in response to the anti-counterfeiting authentication request.

According to an embodiment in another aspect of the present disclosure, a product traceability and anti-counterfeiting authentication assist apparatus is provided, which includes:

a first identification code acquiring unit, configured to acquire a first identification code on a product by a user scan;

a query request generating and sending unit, configured to generate and send a query request corresponding to the first identification code;

a product information receiving and displaying unit, configured to receive the query request and display basic information, a delivery status, and user scanning information of the product matching the first identification code in response to the query request;

a second identification code acquiring unit, configured to acquire the second identification code separated from the product by a user scan;

an anti-counterfeiting authentication request generating and sending unit, configured to generate and send an anti-counterfeiting authentication request corresponding to the second identification code;

an anti-counterfeiting authentication result receiving and displaying unit, configured to receive the anti-counterfeiting authentication request and display an anti-counterfeiting authentication result of the product matching the second identification code in response to the anti-counterfeiting authentication request.

According to an embodiment in another aspect of the present disclosure, a product traceability and anti-counterfeiting authentication method is provided, which includes:

receiving a query request and/or an anti-counterfeiting authentication request sent from a user by scanning the first identification code on a product;

providing basic information, a delivery status, and user scanning information and/or an anti-counterfeiting authentication result of the product matching the first identification code to the user, the first identification code being attached to the product;

receiving a status update request sent from a user by scanning a second identification code, the second identification code being separated from the product; and

setting the delivery status of the product to a sold or consumed status.

According to an embodiment in another aspect of the present disclosure, a product traceability and anti-counterfeiting authentication apparatus is provided, which includes:

a query request receiving unit, configured to receive a query request sent from a user by scanning a first identification code;

a matching information providing unit, configured to provide basic information, a delivery status, and user scanning information of the product matching the first identification code to the user;

an anti-counterfeiting authentication request receiving unit, configured to receive an anti-counterfeiting authentication request sent from a user by scanning the first identification code;

an anti-counterfeiting authentication result providing unit, configured to provide an anti-counterfeiting authentication result of the product matching the first identification code to the user;

a status update request receiving unit, configured to receive a status update request sent from a user by scanning a second identification code separated from the product; and

a product status update unit, configured to set a delivery status of the product to a sold or consumed status.

According to an embodiment in another aspect of the present disclosure, a product traceability and anti-counterfeiting authentication assist method is provided, which includes:

acquiring a first identification code on a product by a user scan;

generating and sending a query request and/or an anti-counterfeiting authentication request corresponding to the first identification code;

receiving the query request and displaying basic information, a delivery status, and user scanning information of the product matching the first identification code in response to the query request;

receiving the anti-counterfeiting authentication request and di splaying an anti-counterfeiting authentication result of the product matching the first identification code in response to the anti-counterfeiting authentication request;

acquiring a second identification code separated from the product by a user scan;

generating and sending a status update request corresponding to the second identification code; and

receiving the status update request and updating a delivery status of the product to a sold or consumed status in response to the status update request.

According to an embodiment in another aspect of the present disclosure, a product traceability and anti-counterfeiting authentication assist apparatus is provided, which includes:

a first identification code acquiring unit, configured to acquire a first identification code on a product by a user scan;

a query request generating and sending unit, configured to generate and send a query request corresponding to the first identification code;

a product information receiving and displaying unit, configured to receive the query request and display basic information, a delivery status, and user scanning information of the product matching the first identification code in response to the query request;

an anti-counterfeiting authentication request generating and sending unit, configured to generate and send an anti-counterfeiting authentication request corresponding to the first identification code;

an anti-counterfeiting authentication result receiving and displaying unit, configured to receive the anti-counterfeiting authentication request and display an anti-counterfeiting authentication result of the product matching the first identification code in response to the anti-counterfeiting authentication request;

a second identification code acquiring unit, configured to acquire a second identification code separated from the product by a user scan;

a status update request generating and sending unit, configured to generate and send a status update request corresponding to the second identification code; and

a status update request receiving and setting unit, configured to receive the status update request and update the delivery status of the product to a sold or consumed status in response to the status update request.

The present disclosure adopts dual layer identification codes including a first identification code and a second identification code, since the matching between the first identification code and the second identification code is irregular or there is no matching relationship therebetween, it is impossible for a counterfeiter to acquire first identification codes and second identification codes of an entire batch of similar products by analyzing the first identification code and the second identification code of one product, thereby improving an anti-counterfeiting efficiency. Moreover, the second identification code is provided by a merchant after the product is purchased, so that the counterfeiter can only acquire the second identification code after purchasing a genuine product, thereby increasing a counterfeiting cost.

### BRIEF DESCRIPTION OF THE DRAWINGS

Other features, objectives, and advantages of the present disclosure will become more apparent by reading the following detailed description of non-limiting embodiments with reference to the accompanying drawings:

FIGS. 1a, 1b and 1c are schematic diagrams of a product having dual layer identification codes according to an embodiment of the present disclosure respectively.

FIG. 2 is a flowchart of a product-tracing anti-counterfeiting authentication method according to an embodiment of the present disclosure.

FIG. 3 is a flowchart of a product traceability and anti-counterfeiting authentication assist method according to an embodiment of the present disclosure.

FIG. 4 is a schematic diagram showing a result indicating information of a provided product according to an embodiment of the present disclosure.

FIG. 5 is a schematic diagram showing a result indicating that a provided product is genuine according to an embodiment of the present disclosure.

FIG. 6 is a schematic diagram showing a result indicating that a provided product is doubtful according to an embodiment of the present disclosure.

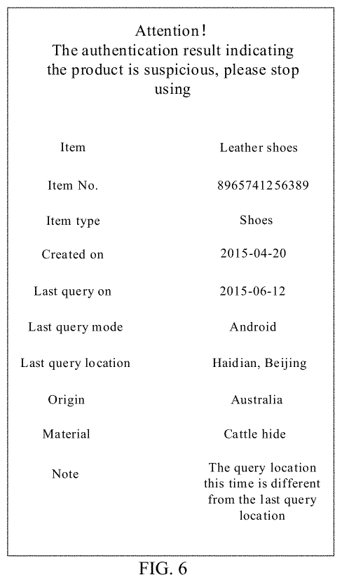

FIG. 7 is a schematic structure diagram of a product traceability and anti-counterfeiting authentication apparatus according to an embodiment of the present disclosure.

FIG. 8 is a schematic structure diagram of a product traceability and anti-counterfeiting authentication assist apparatus according to an embodiment of the present disclosure.

FIG. 9 is a flowchart of a product traceability and anti-counterfeiting authentication method according to another embodiment of the present disclosure.

FIG. 10 is a flowchart of a product traceability and anti-counterfeiting authentication assist method according to another embodiment of the present disclosure.

FIG. 11 is a schematic structure diagram of a product traceability and anti-counterfeiting authentication apparatus according to another embodiment of the present disclosure.

FIG. 12 is a schematic structure diagram of a product traceability and anti-counterfeiting authentication assist apparatus according to another embodiment of the present disclosure.

### DETAILED DESCRIPTION OF THE EMBODIMENTS

Before detailing the exemplary embodiments, it should be noted that some exemplary embodiments are described as processes or methods depicted as flowcharts. Although various operation steps in the flowcharts are described as being processed sequentially, many of these operation steps can be performed in parallel, concurrently, or simultaneously. In addition, the order of the operation steps can be rearranged. The process can be terminated when its operation is complete, and can also include additional steps not shown in the drawings. The process may correspond to a method, a function, a procedure, a subroutine, a subprogram, etc.

The method provided by the present disclosure is implemented on a computer device including a user device and a network device. The user device includes, but is not limited to, a computer, a smartphone, a personal digital assistant (PDA), and the like. The network device includes, but is not limited to, a single network server, a server group consisting of multiple network servers, or a cloud consisting of a large number of computers or network servers based on Cloud Computing. The computer device can operate alone to implement the present disclosure, or can access the network and implement the present disclosure by interacting with other computer devices on the network. The network on which the computer device is located includes, but is not limited to, the Internet, a wide area network (WAN), a metropolitan area network (MAN), a local area network (LAN), a virtual private network (VPN) network, and the like.

It should be noted that the user device, network device, networks, and the like are merely examples, and other existing or possible future computer devices or networks which may be applicable to the present disclosure, are also included within the scope of the present disclosure and are incorporated herein by reference.

The methods discussed below, some of which are shown by the flowcharts, can be implemented by hardware, software, firmware, middleware, microcode, a hardware description language, or any combination thereof. When the methods are implemented in software, firmware, middleware, or microcode, program codes or code segments used for performing the necessary tasks can be stored in a machine or a computer-readable medium, such as a storage medium. One or more processors can perform the necessary tasks.

The specific structural and functional details disclosed herein are representative only and are for the purpose of describing exemplary embodiments of the present disclosure. The present disclosure can, however, be implemented in many alternative forms and should not be construed as limited only to the embodiments set forth herein.

It is to be understood that although the terms “first,” “second,” and the like are used here to describe individual elements, these elements should not be limited by these terms. These terms are used merely for distinguishing one unit from another. For example, the first unit can be referred to as the second unit, and similarly the second unit can be referred to as the first unit, without departing from the scope of the exemplary embodiments. The term “and/or” used here includes any and all combinations of one or more of the listed associated items.

It should be understood that when one unit is referred to as “connected” or “coupled” to another unit, it may be directly connected or coupled to the other unit, or there may be an intermediate unit. Correspondingly, when one unit is referred to as “directly connected” or “directly coupled” to another unit, there is no intermediate unit. Other words (e.g., “located between” versus “directly located between”, “adjacent to” versus “directly adjacent to”, etc.) used for describing the relationship between units should be interpreted similarly.

The terms used here are for the purpose of describing specific embodiments only and is not intended to limit the exemplary embodiments. Unless the context clearly indicates otherwise, the singular forms “a,” “an,” and “an item” are also intended to include the plural. It should also be understood that the terms “comprising” and/or “including” as used here specifies the presence of stated features, integers, steps, operations, units, and/or components, without excluding the presence or addition of one or more other features, integers, steps, operations, units, components, and/or combinations thereof.

It should also be mentioned that in some alternative embodiments, the mentioned functions/actions may take place in an order different from that indicated in the drawings. For example, two diagrams shown in succession may actually be executed substantially simultaneously or may sometimes be executed in a reverse order, depending on the function/action involved.

Embodiments of the present disclosure is described in further detail below with reference to the accompanying drawings.

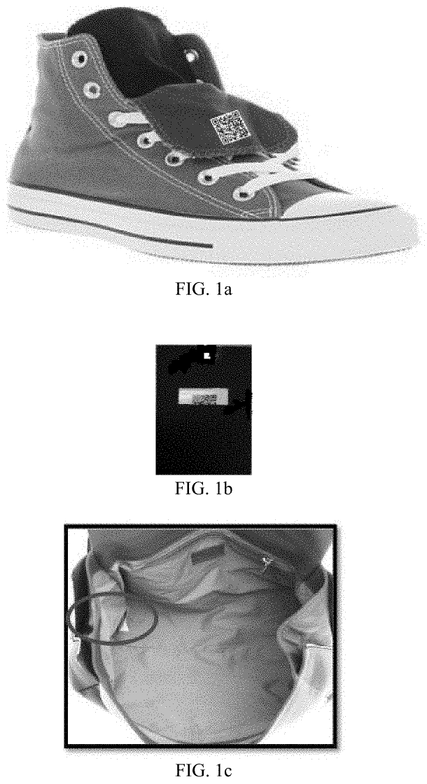

FIGS. 1a to 1b are respectively schematic diagrams of a product having dual layer identification codes according to an embodiment of the present disclosure. A main feature of the dual layer identification codes of the product is that a first identification code of the dual layer identification codes is pasted or printed on the product itself. The first identification code of the dual layer identification codes is directly exposed to an outside or an inside of the product, and can be directly obtained without damaging the product. The second identification code is separated from the product and is delivered to the consumer together with the product when the product is sold. FIGS. 1a and 1b respectively show a first identification code attached to a tongue of a shoe product and a second identification code separated from the product.

FIGS. 1b to 1c are respectively schematic diagrams of a product having dual layer identification codes according to another embodiment of the present disclosure. FIG. 1c shows a handbag with a two-dimensional code. The first identification code is located on an inner surface of the handbag without affecting an appearance of the handbag and can be directly obtained without damaging the handbag, as shown in FIG. 1c. The second identification code is located on a surface layer of a separate card that is separated from the product where the first identification code is located, as shown in FIG. 1b.

It should be noted that the product having the dual layer identification codes referred to in the present disclosure is not limited to the above two embodiments, as long as the product has the following features: the first identification code of the dual layer identification codes of the product is printed or pasted on the product, and the second identification code is separated from the product; the first identification code is directly exposed to the surface layer of the product and can be directly obtained without damaging the product; the second identification code is separated from the product and is obtained by purchasing a genuine product. These features all fall in the scope of protection of the present disclosure.

Advantages of the product having the dual layer identification codes are that since the second identification code is separated from the product on which the first identification code is located and the second identification code is provided to the consumer only when the product is sold, if a person wants to add an anti-counterfeiting code to a counterfeit product by copying the first identification code and the second identification code of the genuine product, it is necessary to purchase the genuine product to obtain the dual layer identification codes, so that the counterfeiting cost is high; furthermore, in an embodiment of the present disclosure, the first identification code can match a plurality of second identification codes, and a matching relationship can be random without a rule, and the matching relationship uniquely match the product on which the dual layer identification codes are located. It should be further noted that, since the first identification code can match the plurality of second identification codes, when the second identification code is provided to the consumer when the product is sold, it is not necessary to provide a specific second identification code, that is, the second identification code provided to the consumer is any one of the plurality of second identification codes that match the product. Furthermore, the dual layer identification codes are any combination of a two-dimensional code, a bar code, a near field communication (NFC) code, and a non-contact radio frequency identification (RFID) code; that is, the first identification code or the second identification code may be any one of the above, and the second identification code may be the same as or different from the first identification code. Types of the first identification codes of different items of the similar products can be different, and types of the second identification codes of different items of the similar products can also be different. Therefore, a counterfeiter cannot acquire dual layer identification codes matching other similar products by purchasing only a single genuine product and analyzing the first identification code and the second identification code of the product respectively, accordingly, it is very difficult to counterfeit. Therefore, the product having the dual layer identification codes has higher anti-counterfeiting characteristics.

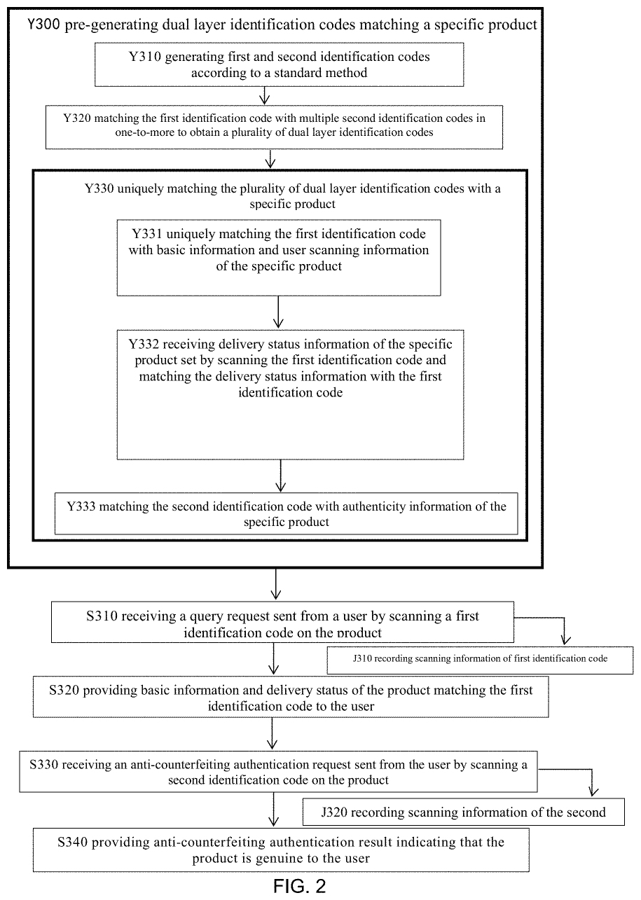

FIG. 2 is a flowchart of a product traceability and anti-counterfeiting authentication method according to an embodiment of the present disclosure, the method mainly including the following steps.

Y300: dual layer identification codes matching a specific product are pre-generated.

S310: a query request sent from a user by scanning a first identification code on the product is received.

S320: basic information, a delivery status, and user scanning information of the product matching the first identification code are provided to the user.

S330: an anti-counterfeiting authentication request sent from the user by scanning a second identification code of the product is received; the second identification code is separated from the product.

S340: it is determined whether a time interval between receiving the query request and receiving the anti-counterfeiting authentication request satisfies a preset threshold value.

S350: if yes, an anti-counterfeiting authentication result of the product matching the second identification code is provided to the user.

The step Y300 specifically includes following steps.

Y310: a first identification code and a second identification code are respectively generated according to a standard method.

Y320: the first identification code is matched with a plurality of second identification codes to obtain a plurality of dual layer identification codes.

Y330: the plurality of dual layer identification codes are uniquely matched with a specific product.

The step Y330 specifically includes following steps.

Y331: the first identification code is uniquely matched with the basic information of the specific product.

Y332: delivery status information of the specific product set by scanning the first identification code is received and the delivery status information is matched with the first identification code.

Y333: the second identification code is matched with authenticity information of the specific product.

In order to further understand the present disclosure, the above steps are described in further detail below.

The dual layer identification codes described in the step Y300 are, but are not limited to, any combination of a two-dimensional code, a bar code, a near field communication (NFC) code, and a non-contact radio frequency identification (RFID) code. That is, the first identification code or the second identification code can be any one of the above, and the second identification code can be the same as or different from the first identification code. The step Y300 is a step which is completed in advance. When the present disclosure is actually executed, the execution can begin with the step S310, that is, the initial step Y300 can be omitted.

The standard method for generating the first identification code and the second identification code described in the step Y310 refers to a mature technique method for generating a two-dimensional code, a bar code, a near field communication (NFC) code, and a non-contact radio frequency identification (RFID) code, which will not be explained in detail herein.

It should be appreciated that the second identification code in the present disclosure comes with the product when the product leaves a factory.

It should be noted that the second identification code is separated from the product, and is provided to the consumer only when the product is sold. When the second identification code is lost due to improper storage, the store needs to apply to the manufacturer for reissuing a second identification code.

Alternatively, the transportation problem of the second identification code is taken into account, since the second identification code is separated from the product, and the second identification code is inconvenient to keep and is easily lost during the transportation, the second identification code can also be printed out and provided to the consumer with the product when the product is sold.

Alternatively, in the event of a return/change of a product, since the second identification code may be scanned and verified by the consumer who applies for returning/changing the product. In this case, the consumer who purchases the product again cannot verify the authenticity of the product through the second identification code due to the foregoing authentication rule.

Therefore, when the product is resold, the second identification code corresponding to the product and provided to the consumer when the product is sold for the first time is invalid, the store where the product is sold applies again to the manufacturer for printing the second identification code, and the second identification code contains information indicating a second sale.

An embodiment is provided as follows. when the product is sold, a salesperson of a store where the product is sold submits a second identification code acquisition request via a network, and a manufacturer who produces the product acquires one second identification code from a group of second identification codes matching the first identification code of the product according to the received request, and issues the second identification code to the store, then the store prints and delivers the second identification code to the consumer who purchases the product.

The process of acquiring the second identification code from the group of second identification codes may be regular or irregular.

Furthermore, when the second identification code is printed, a protective layer is provided for the second identification code. When an anti-counterfeiting authentication is required, the protective layer must be destroyed to scan the second identification code, that is, the second identification code is not directly exposed.

The step of matching the first identification code with the second identification codes in a one-to-many mode to obtain the dual layer identification codes in step Y320 specifically includes, but is not limited to: a plurality of second identification codes are simultaneously generated and matched while the first identification code is generated; or, after a first identification code set and a second identification code set are generated, an element of the first identification code set is randomly matched with an element of the second identification code set; or, the matching is performed according to a specific function; or, elements in the first identification code set are interchanged with the elements in the second identification code set, and then the matching is performed one by one. Any irregular matching mode shall fall within the scope of the present disclosure. Because of the irregularity of the matching mode between the first identification code and the second identification code, it is impossible for the counterfeiter to obtain the first identification codes and the second identification codes of all similar products by analyzing the first identification code and the second identification code of one product, thereby improving the anti-counterfeiting efficiency.

Alternatively, the second identification code can so be generated when the product is sold. A generation method includes the second identification code is generated by matching the first identification code of the product according to a store number and time indicated in the request information submitted by the store.

In the specific steps of the step Y330, in the step Y331 the first identification code is uniquely matched with the basic information of the specific product, the matching of the basic information of the product is completed by a product manufacturer or a designated authorized distributor, and the basic information of the product includes, but is not limited to, a product name, a product type, a product number, a product origin, a product raw material, and the like.

In the step Y332, the delivery status information of the specific product set by scanning the first identification code is received, and the delivery status information is matched with the first identification code. The delivery status information includes, but is not limited to, a creation time, a scanning time history of a carrier or distributor, a scanning location history, a carrier or distributor basic information history, and the like. The product manufacturer, carrier, or distributor scans the first identification code of the specific product to match the delivery status information with the first identification code of the product, and the delivery status information is continuously updated during the change in the delivery process of the product. The creation of the delivery status information can implement accurate recording and tracking of the delivery status of each product. With the support of the information, the product traceability and the product anti-channel conflict can be well implemented, and the authenticity of the product can be determined by verifying the information.

Through the above two steps, the matching of the product information with the first identification code is completed.

In the step Y333, the second identification code is matched with the authenticity information of the specific product. The authenticity information includes information indicating that the product is a genuine product and information indicating that the product is suspicious. The information indicating that the product is a genuine product is matched with the second identification code of the product by the manufacturer or designated authorized distributor of the product before leaving the factory or before sale of the product; the information indicating that the product is suspicious is automatically matched with the second identification code after the second identification code of the product is scanned for the first time and when the second identification code is, without authorization, scanned for a second time and multiple times.

The above-mentioned matching relationship includes a matching relationship between the first identification code and the second identification code, a matching relationship between the first identification code, and the basic information and the delivery information of the product, and a matching relationship between the second identification code and the authenticity information of the product. Accordingly, the matching of the dual layer identification codes with the product is completed.

Although the FIG. 2 shows that the step Y330 includes the steps Y331 to Y333, the step Y330 may be implemented through other modes or include other steps.

Although the FIG. 2 shows that the step Y300 includes the steps Y310 to Y330, the step Y300 may be implemented through other modes or include other steps.

It should be noted that in order to prevent the dual layer identification codes from being maliciously tampered, a data encryption technique is adopted in the steps of generating, sending and printing, storing and subsequent querying of the dual layer identification codes, to effectively ensure that the dual layer identification codes is always in a security state.

In the step S310, a query request sent from the user by scanning the first identification code is received. The method for scanning the first identification code includes steps that, but is not limited to, an existing scanning tool (such as WeChat) of an intelligent mobile terminal is adopted, or a dedicated APP (application) developed for implementing the method of the present disclosure, hereinafter referred to as an anti-counterfeiting authentication APP, is adopted.

Since the user can quickly learn and master the usage and function of the APP software installed in the intelligent mobile terminal, the solution of the embodiment of the present disclosure can allow the user to easily and simply query the source of the product without using a special detection tool or mastering special technical knowledge, thereby effectively reducing the query difficulty. In addition, the credibility of the user in the product authentication information is improved while the query is performed by means of the anti-counterfeiting authentication APP.

After the step S310, the method may further In one embodiment include a step J310, in which a number, time, a location of scanning of the first identification code by the user, and user information, collectively referred to as user scanning information, are recorded, and the user scanning information is matched with the first identification code.

In the step S320, the basic information, the delivery status information, and the user scanning information of the product are provided to the user. Since the first identification code is associated with the basic information, the delivery status information and the user scanning information of the product, the basic information, the delivery status information, and the user scanning information of the product associated with the first identification code can be provided to the user after the user scans the first identification code.

In addition, since dual layer identification codes are adopted in the present embodiment of the present disclosure, the second identification code cannot be directly acquired, but can be acquired after the product is purchased. A new user may not know the existence of the second identification code. Accordingly, when the user sends a query request by scanning the first identification code, prompt information indicating that an anti-counterfeiting authentication result can be acquired by scanning the second identification code can be returned to the user.

It should be noted that before the second identification code is scanned, each time the first identification code is scanned, the basic information, the delivery information, and the user scanning information of the corresponding product can be prompted, and the corresponding query behavior is recorded each time.

In the step S330, an anti-counterfeiting authentication request sent from the user by scanning the second identification code for the first time is received; and the scanning method can be the same as that described in the step S310.

After the step S330, the method may further In one embodiment include a step J320, in which a number, time, a location of scanning of the second identification code by the user, and user information, collectively referred to as user scanning information, are recorded, and the user scanning information is matched with the product.

In the step S340, an anti-counterfeiting authentication result of the product matching the second identification code is provided to the user.

If the second identification code is scanned for the first time, and the second identification code is pre-generated and is matched with the second identification code corresponding to the first identification code, an anti-counterfeiting authentication result indicating that the product is a genuine product is provided to the user performing the scanning, and a delivery status of the product is set to a sold or consumed status;

If the second identification code is scanned again and the user performing the scanning is not specially authorized, an anti-counterfeiting authentication result indicating that the product is suspicious is provided to the user performing the scanning;

If the second identification code is not the pre-generated second identification code corresponding to the first identification code, an anti-counterfeiting authentication result indicating that the second identification code is not an anti-counterfeiting authentication code provided by a manufacturer or a designated authorized distributor of the product or that the product is suspicious, is provided to the user performing the scanning.

When the second identification code is scanned for the first time, and the second identification code is a pre-generated second identification code corresponding to the first identification code, the delivery status of the product is set to a sold or consumed status, so that if a query request sent from the user by scanning the first identification code who has no special authorization is received again, an anti-counterfeiting authentication result indicating that the product is suspicious is provided to the user. Generally, only when the second identification code is scanned for the first time and the second identification code is a pre-generated second identification code corresponding to the first identification code, an anti-counterfeiting authentication result indicating that the product is a genuine product is provided to the user. If the authentication result indicates that the product is suspicious when the second identification code is scanned, it implies that the second identification code may have been scanned, and the corresponding product may have been sold or consumed. The second identification code of the product that has been sold or consumed is again scanned, which may be a counterfeiting behavior performed by a counterfeiter using the genuine packaging, in this way the authenticity of the product can be effectively verified. A user who is not specially authorized here includes a user who performs second scanning of the second identification code but does not perform first scanning of the second identification code, and a user who performs the second scanning of the second identification code but does not receive an authorization from a user who performs the first scanning of the second identification code or from an authorized user who performs the last scanning of the second identification code. At the same time, it should be noted that when an anti-counterfeiting authentication request from an unauthorized user by scanning the second identification code is received, the scanning time, the location, and the user information of the user who performs the scanning of the second identification code are recorded, and the information is matched with the product, so that which product may be counterfeited and in which place or area the product may be counterfeited can be known by inquiring the information of the product and the scanning information of the unauthorized user, to provide the manufacturer, the carrier, and the distributor with a way to track and fight against the counterfeiting.

It will be appreciated that after receiving the anti-counterfeiting authentication request sent from the user by scanning the second identification code, the basic information and the delivery information of the product can be provided in addition to the related content of the authenticity authentication result.

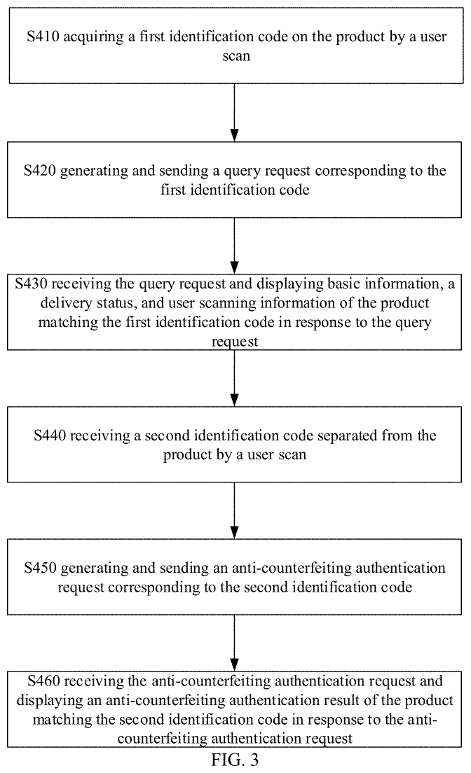

The embodiment of the present disclosure further provides a product traceability and anti-counterfeiting authentication assist method corresponding to the above-mentioned product traceability and anti-counterfeiting authentication method. A flowchart of the assist method is as shown in FIG. 3, and the method mainly includes the following steps.

S410: a first identification code on the product is acquired by a user scan.

S420: a query request corresponding to the first identification code is generated and sent.

S430: the query request is received and basic information, a delivery status, and user scanning information of the product matching the first identification code is displayed in response to the query request.

S440: a second identification code separated from the product is acquired by the user scan.

S450: an anti-counterfeiting authentication request corresponding to the second identification code is generated and sent.

S460: an anti-counterfeiting authentication request is received and an anti-counterfeiting authentication result of the product matching the second identification code is displayed in response to the anti-counterfeiting authentication request.

In one embodiment, after the step S430, the method further includes: the user is prompted to scan the second identification code within a preset period.

In one embodiment, if the anti-counterfeiting authentication result indicates that the product is genuine, the method further includes:

the product is added into a list of purchased products of the user.

the list of purchased products of the user is displayed;

first identification code user scanning information and second identification code user scanning information of a selected product is displayed in response to a selection of the user;

an operating button is provided and information of the corresponding product is sent to the manufacturer in response to a returning/changing or maintenance service operation of the user;

A store where the product can be dealt with and a distance from the user to the store are correspondingly displayed in response to the returning/changing or maintenance service operation of the user.

The content of each step will be explained in detail below.

The method described in the step S410 includes, but is not limited to, an existing scanning tool (such as WeChat) of an intelligent mobile terminal, or a dedicated APP (Application) developed for implementing the method of the present disclosure, hereinafter referred to as an anti-counterfeiting authentication APP, is adopted.

Since the user can quickly learn and master the APP software installed in the intelligent mobile terminal, the solution of the embodiment of the present disclosure can allow the user to easily and simply query the source of the product without using a special detection tool or mastering special technical knowledge, thereby effectively reducing the query difficulty. In addition, the credibility of the user in the product authentication information is improved by querying via the anti-counterfeiting authentication APP.

In the step S420, a query request corresponding to the first identification code is generated and sent. After the first identification code is scanned by using an existing scanning tool (e.g., WeChat) of the intelligent mobile terminal or using a dedicated APP (Application) developed for implementing the method of the present disclosure, the scanning tool (e.g., WeChat) or the dedicated APP (Application) sends a query request corresponding to the first identification code to a merchant server or a third-party server.

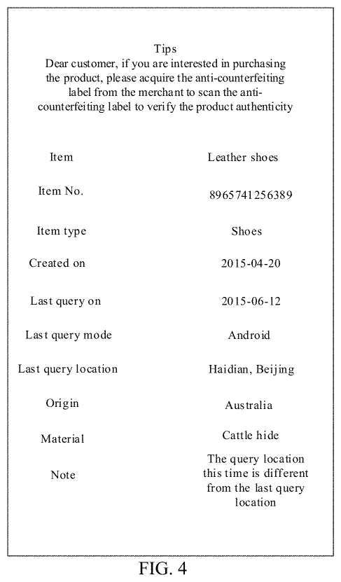

In the step S430, the query request is received and basic information, a delivery status, and user scanning information of the product matching the first identification code are displayed in response to the query request. After the merchant server or the third-party server receives the query request, since the merchant server or the third-party server stores basic information, delivery statuses, and the user scanning information of the products matching various first identification codes, and the basic information, the delivery status, and the user scanning information of the product matching the first identification code are sent to the user. FIG. 4 shows the basic information, the delivery status information, and the user scanning information of the product received and displayed to the user (the basic information, the delivery status information, and the user scanning information of the provided product are displayed on multiple pages).

The function of prompting the user to scan the second identification code is that: since the dual layer identification codes are adopted in the embodiment of the present disclosure, the second identification code cannot be directly acquired, but can be acquired after the product is purchased, and a new user may not know the existence of the second identification code. Therefore, the prompt assists the user in completing anti-counterfeiting authentication according to the prompt result. FIG. 4 also shows a content of a prompt that “Dear customer, if you are interested in purchasing the product, please acquire an anti-counterfeiting label from the merchant to verify the authenticity of the product by scanning the anti-counterfeiting label” which prompts the user to scan the second identification code to obtain the authenticity authentication result of the product. The basic information, the delivery status information, and the user scanning information of the product provided to the user can be displayed in an interface of the anti-counterfeiting authentication APP.

In the step S440, a second identification code on the product is acquired by the user scan. The scanning method can be the same as the scanning method in the step S410.

In the step S450, an anti-counterfeiting authentication request corresponding to the second identification code is generated and sent. After the second identification code is scanned by using an existing scanning tool (e.g., WeChat) of the intelligent mobile terminal or using a dedicated Application (APP) developed for implementing the method of the present disclosure, the scanning tool (e.g., WeChat) or the dedicated Application (APP) sends an anti-counterfeiting authentication request corresponding to the second identification code to the merchant server or the third-party server.

In the step S460, the anti-counterfeiting authentication request of the product matching the second identification code is received and displayed to the user in response to the anti-counterfeiting authentication request. Since the merchant server or the third-party server stores the user scanning information, the anti-counterfeiting authentication result can be sent to the user according to the stored user scanning information.

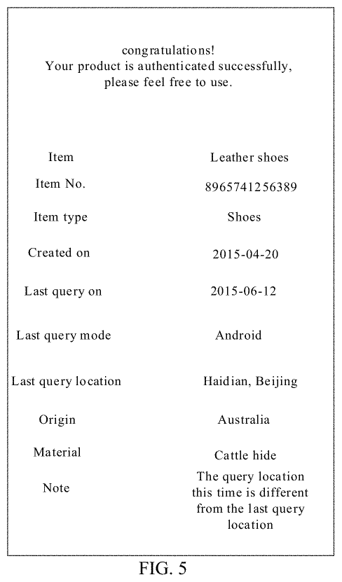

If the merchant server or the third-party server receives the anti-counterfeiting authentication request sent from the user by scanning the second identification code for the first time, and the second identification code is a pre-generated second identification code corresponding to the first identification code, the merchant server or the third-party server receives and displays the anti-counterfeiting authentication result indicating that the product is a genuine product to the user, the prompt interface can be shown in FIG. 5.

The step of adding the product into the list of purchased products of the user functions to facilitate the user to manage the purchased products, a management operation includes, but is not limited to, resale, repair, return/change, and the like. In order to facilitate the user to manage the purchased products, after the step of adding the product to a list of purchased products of the user, the method further includes: the list of purchased products of the user is displayed; the list of purchased products of the user displays basic information of the product purchased by the user and provides an operating button; first identification code user scanning information and second identification code user scanning information of selected product are displayed in response to a selection of the user; the first identification code user scanning information and the second identification code user scanning information have been described in detail in the above and will not be repeated herein; the operating button provided in the interface of the list of purchased products includes a returning/changing operation button and a maintenance service operation button, and information of the corresponding product including the basic information, the delivery status information, and the user scanning information of the product is sent to the manufacturer in response to the returning/changing or maintenance service operation of the user, and a store where the corresponding product can be dealt with and a distance from the store to the user are displayed in response to the returning/changing or maintenance service operation of the user, to facilitate the user to select a nearby store for a corresponding treatment.

It should be appreciated that the operating button also includes an operation option such as comment, lottery, receiving coupons and/or red packets, product maintenance knowledge, recommended collocation, and sharing, etc., through which a user can comment on a product, participate in a lottery activity, receive a coupon and/or a red packet, learn about maintenance knowledge of the product, view other products recommended for collocation with the product, and share the product with friends. The multiple operation options provided for the user in this embodiment improve the interaction experience of the user and facilitate the promotion activities of the merchant.

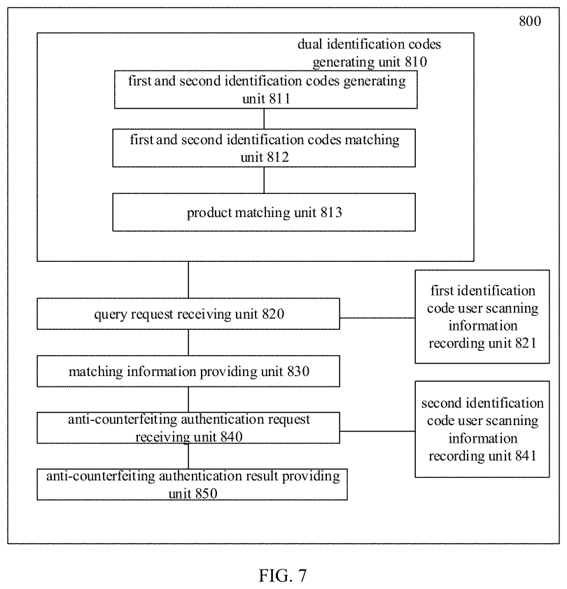

After the second identification code is scanned for the first time, the delivery status of the product is set to the sold status, so that if the second identification code is scanned again and the scanning is not authorized, an anti-counterfeiting authentication result indicating that the product is suspicious is received and displayed to the user, and a corresponding prompt interface can be shown in FIG. 7. Generally, an anti-counterfeiting authentication result indicating that the product is genuine is provided to the user only when the second identification code is scanned for the first time. If the authentication result indicates that the product is suspicious when the second identification code is scanned, it implies that this is not the first time the second identification code has been scanned, and the corresponding product may have been sold or consumed. The second identification code of the product that has been sold or consumed is again scanned, which may be a counterfeiting behavior performed by a counterfeiter using the genuine packaging, in this way, the authenticity of the product can be effectively verified. A user who is not specially authorized here includes a user who performs second scanning of the second identification code but does not perform first scanning of the second identification code, and a user who performs the second scanning of the second identification code but does not receive an authorization from a user who performs the first scanning of the second identification code or from an authorized user who performs the last scanning of the second identification code. At the same time, it should be noted that when an anti-counterfeiting authentication request from an unauthorized user by scanning the second identification code is received, the scanning time, the location, and the user information of the user performing the scanning of the second identification code are recorded, and these information is matched with the product, so that which product may be counterfeited and in which place or area the product may be counterfeited can be known by inquiring the information of the product and the scanning information of the unauthorized user, to provide the manufacturer, the carrier, and the distributor with a way to track and fight against the counterfeiting.

An embodiment of the present disclosure further provides a product traceability and anti-counterfeiting authentication apparatus 800 corresponding to the product traceability and anti-counterfeiting authentication method. As shown in FIG. 7, which shows a schematic structure diagram of the apparatus. The apparatus 800 mainly includes the following units:

a query request receiving unit 820, configured to receive a query request sent from a user by scanning a first identification code;

a matching information providing unit 830, configured to provide basic information, a delivery status, and user scanning information of the product matching the first identification code to the user;

an anti-counterfeiting authentication request receiving unit 840, configured to receive an anti-counterfeiting authentication request sent from the user by scanning a second identification code;

an anti-counterfeiting authentication result providing unit 850, configured to provide an anti-counterfeiting authentication result of the product matching the second identification code to the user.

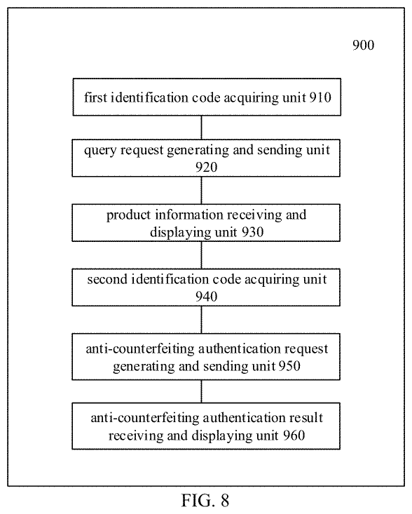

Although other elements are also shown in the FIG. 8, these elements are all embodiments of the present disclosure do not depend on these elements.

In one embodiment, the apparatus 800 further includes a dual layer identification codes generating unit 810 configured to pre-generate dual layer identification codes matching a specific product. The dual layer identification codes generating unit 810 specifically includes:

a first and second identification codes generating unit 811, configured to generate a first identification code and a second identification code according to a standard method, respectively;

a first and second identification codes matching unit 812, configured to perform a one-to-many matching between the first identification code and the second identification codes to obtain a plurality of dual layer identification codes;

a product matching unit 813, configured to uniquely match the dual layer identification codes to a specific product.

Alternatively, the product matching unit 813 is configured to:

uniquely match the first identification code with basic information of the specific product;

receive delivery status information of the specific product set by scanning the first identification code, and match the delivery status information with the first identification code;

and match the second identification code with authenticity information of the specific product.

In one embodiment, the apparatus 800 further includes a first identification code user scanning information recording unit 821 configured to: record a number, time, a location of scanning of the first identification code by the user and user information as the first identification code user scanning information after receiving the query request sent from the user by scanning the first identification code, and match the first identification code user scanning information with the first identification code.

In one embodiment, the apparatus 800 further includes a second identification code user scanning information recording unit 841 configured to: record a number, time, a location of the scanning of the second identification code and user information, collectively referred to as second identification code user scanning information, after receiving the anti-counterfeiting authentication request sent from the user by scanning the second identification code, and match the second identification code user scanning information with the product.

In one embodiment, the anti-counterfeiting authentication result providing unit 850 is configured to:

provide an anti-counterfeiting authentication result indicating that the product is a genuine product to a user performing the scanning, and set a delivery status of the product to a sold or consumed status if the second identification code is scanned for the first time and the second identification code is a pre-generated second identification code corresponding to the first identification code;

provide an anti-counterfeiting authentication result indicating that the product is suspicious to the user performing the scanning if the second identification code is scanned again and the user performing the scanning is not specially authorized;

provide an anti-counterfeiting authentication result indicating that the second identification code is not an anti-counterfeiting authentication code provided by a manufacturer or a designated authorized distributor of the product or that the product is suspicious to the user who performs the scanning if the second identification code is not a pre-generated second identification code corresponding to the first identification code.

Alternatively, the dual layer identification codes are any combination of a two-dimensional code, a bar code, a near field communication (NFC) code, and a non-contact radio frequency identification (RFID) code.

An embodiment of the present disclosure further provides a product traceability and anti-counterfeiting authentication assist apparatus 900 corresponding to the above-mentioned product traceability and anti-counterfeiting authentication apparatus. As shown in FIG. 8, the apparatus includes the following units:

a first identification code acquiring unit 910, configured to acquire a first identification code on a product by a user scan;

a query request generating and sending unit 920, configured to generate and send a query request corresponding to the first identification code;

a product information receiving and displaying unit 930, configured to receive the query request and display basic information, a delivery status, and user scanning information of the product matching the first identification code in response to the query request;

a second identification code acquiring unit 940, configured to acquire a second identification code on the product by a user scan;

an anti-counterfeiting authentication request generating and sending unit 950, configured to generate and send an anti-counterfeiting authentication request corresponding to the second identification code;

an anti-counterfeiting authentication result receiving and displaying unit 960, configured to receive the anti-counterfeiting authentication request and display an anti-counterfeiting authentication result of the product matching the second identification code in response to the anti-counterfeiting authentication request.

In one embodiment, the apparatus further includes a prompt unit (not shown) configured to prompt the user to scan the second identification code when receiving the query request and display basic information, the delivery status, and the user scanning information of the product matching the first identification code in response to the query request.

In one embodiment, the apparatus further includes a purchased product displaying unit (not shown) configured to:

add the product to a list of purchased products of the user and display the list.

In one embodiment, the apparatus further includes a maintenance and displaying unit (not shown) configured to:

display the list of purchased products of the user;

display first identification code user scanning information and second identification code user scanning information of a selected product in response to a selection of the user;

provide an operating button and send information corresponding to the product to the manufacturer in response to a returning/changing or maintenance service operation of the user.

In one embodiment, the maintenance and displaying unit is further configured to display a corresponding store capable of dealing with the product and a distances from the user to the store in response to the returning/changing or maintenance service operation of the user.

It will be appreciated that the operating button also include an operation option such as comment, lottery, receiving a coupon and/or a red packet, product maintenance knowledge, recommended collocation, and sharing, etc., through which a user can comment on a product, participate in a lottery activity, receive a coupon and/or a red packet, learn about the maintenance knowledge of the product, view other products recommended for collocation with the product, and share the product with friends. The multiple operation options provided for the user in this embodiment improve the interaction experience of the user and facilitate the promotion activities of the merchant.

In view of the above, in an embodiment of the present disclosure, the present disclosure adopts the dual layer identification codes including the first identification code and the second identification code, since a matching mode between the first identification code and the second identification code is irregular, the counterfeiter cannot acquire the first identification codes and the second identification codes of the whole batch of similar products by analyzing a first identification code and a second identification code of one product, thereby improving the anti-counterfeiting efficiency. Moreover, the second identification code should be acquired by tearing the first identification code or damaging the product, so that the counterfeiter can only acquire the second identification code after purchasing a genuine product, thereby increasing the counterfeiting cost. In addition, in the present disclosure, the delivery status of a product is updated by recording a number of scanning of the second identification code, an another unauthorized scanning of the second identification code results in a prompt indicating that the product is suspicious, thereby substantially blocking a possibility of reperfusion using the genuine product package by the counterfeiter to manufacture a counterfeit product and successfully sell the counterfeit product; and the record of another unauthorized scanning activity on the second identification code can also facilitate the manufacturers, carriers, and distributors to track and fight against potential counterfeiting activities. In addition, the mode in which the dual layer identification codes uniquely matches the basic information, the delivery status information, the user scanning information of the product, and the authenticity information of the product also provides a guarantee for tracking and tracing the product, product anti-channel conflict, and checking the authenticity according to the delivery information of the product. In the anti-counterfeiting method and apparatus provided in the present disclosure, the anti-counterfeiting authentication query can be implemented only by a simple operation of scanning the dual layer identification codes. From to the above features, the product having dual layer identification codes and the anti-counterfeiting method and apparatus provided in the present disclosure greatly improve the anti-counterfeiting effect.

In another embodiment of the present disclosure, there is no matching relationship between the first identification code and the second identification code, and the first identification code uniquely matches a product on which the first identification code is located. In addition, it should be noted that since there is no matching relationship between the first identification code and the second identification code, when the second identification code is provided to a consumer when the product is sold, it is not necessary to provide a specific second identification code, that is, the second identification code provided to the consumer is any one of a plurality of second identification codes. Furthermore, the dual layer identification codes include any combination of a two-dimensional code, a bar code, a near field communication (NFC) code, and a non-contact radio frequency identification (RFID) code; that is, both the first identification code or the second identification code can be any one of the above, and the second identification code can be the same as or different from the first identification code. The types of the first identification codes of different items of similar products can be different, and the types of the second identification codes of different items of similar products can also be different. Therefore, a counterfeiter cannot acquire dual layer identification codes matching other similar products by purchasing only a single genuine product of a product type and analyzing the first identification code and the second identification code of the product respectively; accordingly, it is very difficult to counterfeit. Therefore, the product having the dual layer identification codes has a high anti-counterfeiting characteristic.

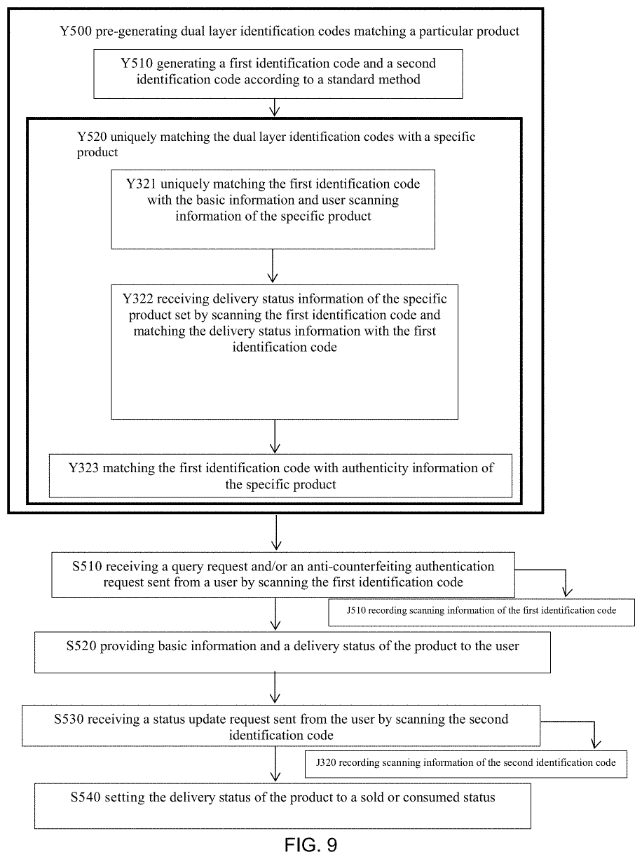

FIG. 9 is a flowchart showing a product traceability and anti-counterfeiting authentication method according to an embodiment of the present disclosure, the method mainly includes the following steps.

Y500: dual layer identification codes matching a specific product are pre-generated.

S510: a query request and/or an anti-counterfeiting authentication request sent from a user by scanning a first identification code on a product are received.

S520: basic information, a delivery status, user scanning information and/or an anti-counterfeiting authentication result of the product matching the first identification code are provided to a user; the first identification code is attached to the product.

S530: a status update request sent from the user by scanning the second identification code is received; the second identification code is separated from the product.

S540: the delivery status of the product is set to a sold or consumed status.

The step Y500 specifically includes the following steps.

Y510: a first identification code and a second identification code are generated according to a standard method, respectively.

Y520: the first identification code is uniquely matched with a specific product.

The step Y520 specifically includes the following steps.

Y521: the first identification code is uniquely matched with the basic information of the specific product.

Y522: delivery status information of the specific product set by scanning the first identification code is received, and the delivery status information is matched with the first identification code.

Y523: the first identification code is matched with authenticity information of the specific product.

For a further understanding of the present disclosure, the above steps are described in further detail below.

The dual layer identification codes described in the step Y500 is, but not limited to, any combination of a two-dimensional code, a bar code, a near field communication (NFC) code, and a non-contact radio frequency identification (RFID) code. That is, the first identification code or the second identification code can be any one of the above, and the second identification code can be the same as or different from the first identification code. The step Y500 is a step which is completed in advance. When the present disclosure is actually implemented, it starts from the step S510, that is, the initial step Y500 can be omitted.

The standard method for generating the first identification code and the second identification code described in the step Y510 refers to a mature technique method for generating a two-dimensional code, a bar code, a near field communication (NFC) code, and a non-contact radio frequency identification (RFID) code generation method, which will not be explained in detail herein.

It should be appreciated that the second identification code in the present disclosure comes with the product when the product leaves a factory.

It should be noted that the second identification code is separated from the product, and is provided to the consumer only when the product is sold. When the second identification code is lost due to improper storage, the store needs to apply to the manufacturer for reissuing a second identification code.

Alternatively, the transportation problem of the second identification code is taken into account, since the second identification code is separated from the product, and the second identification code is inconvenient to keep and s easily lost during the transportation, the second identification code can also be printed out and provided to the consumer with the product when the product is sold.

Alternatively, in the event of a return/change of a product, since the second identification code may be scanned and verified by the consumer who applied for changing/returning the product. In this case, the consumer who purchases the product again cannot update the status of the product through the second identification code due to the foregoing authentication rule.

Therefore, when the product is resold, the second identification code corresponding to the product and provided to the consumer when the product is sold for the first time is invalid, the store where the product is sold applies again to the manufacturer for printing the second identification code, and the second identification code contains information indicating a second sale.

An optional embodiment is provided as follows: when the product is sold, a salesperson of a store where the product is sold submits a second identification code acquisition request via a network, and a manufacturer who produces the product acquires one second identification code from a group of second identification codes matching the first identification code of the product according to the received request, and issues the second identification code to the store, then the store prints and delivers the second identification code to the consumer who purchases the product.

The process of acquiring the second identification code from the group of second identification codes may be regular or irregular.

Furthermore, when the second identification code is printed, a protective layer is provided for the second identification code. When an anti-counterfeiting authentication is required, the protective layer must be destroyed to scan the second identification code, that is, the second identification code is not directly exposed.

For the specific steps of the step Y520, in the step Y521, the first identification code is uniquely matched with the basic information of the specific product. The matching of the basic information of the product is completed by a product manufacturer or a designated authorized distributor, and the basic information of the product includes, but is not limited to, a product name, a product category, a product number, a product origin, a product raw material, and the like.

In the step Y522, the delivery status information of the specific product set by scanning the first identification code is received and is uniquely matched with the first identification code. The delivery status information includes, but is not limited to, a creation time, a scanning time history of a carrier or distributor, a scanning location history, a carrier or distributor basic information history, and the like. The delivery status information is matched with the first identification code of the product by means of scanning the first identification code of the specific product by the product manufacturer, carrier, and distributor, and the delivery status information is continuously updated during the change of the product delivery. The creation of the delivery status information enables to implement accurate record and tracking of the delivery status of each product. With the support of the information, the product traceability and the product anti-channeling conflict can be well realized, and the authenticity of the product can be determined by verifying the information.

Through the above two steps, the matching of the product information with the first identification code is completed.

In the step Y523, the first identification code is matched with the authenticity information of the specific product. The authenticity information includes information indicating that the product is genuine and information indicating that the product is suspicious. The information indicating that the product is genuine is matched with the first identification code of the product by the manufacturer or designated authorized distributor of the product before the product leaves a factory or is sold.

The above matching relationship includes a matching relationship of the first identification code with the basic information and the delivery information of the product, and a matching relationship between the first identification code and the authenticity information of the product. Accordingly, a matching of the dual layer identification codes with the product is completed.

Although the step Y520 shown in FIG. 9 includes the steps Y521 to Y523, the step Y520 can also be implemented in other modes or include other steps.

Although the step Y500 shown in FIG. 9 includes the steps Y510 to Y520, the step Y500 can also be implemented in other modes or include other steps.

It should be noted that in order to prevent the dual layer identification codes from being maliciously tampered, a data encryption technique and authorization and access management of a system function are adopted in the steps of generating, sending and printing, saving, and subsequent querying of the dual layer identification codes, to effectively ensure that the dual layer identification codes are always in a security state.

In the step S510, a query request and/or anti-counterfeiting authentication request sent from the user by scanning the first identification code are received; the method for scanning the first identification code includes, but is not limited to, an existing scanning tool (such as WeChat) of an intelligent mobile terminal is used, or a dedicated APP (an application) developed for implementing the method of the present disclosure, hereinafter referred to as an anti-counterfeiting authentication APP, is used.

Since the user can quickly learn and master the APP software installed in the intelligent mobile terminal, the solution of the embodiment of the present disclosure can allow the user to easily and simply query the source of the product without using a special detection tool or mastering special technical knowledge, thereby effectively reducing the query difficulty. In addition, the credibility of the user in the product authentication information is improved by querying via the anti-counterfeiting authentication APP.

After the step S510, the method further In one embodiment includes a step J510 of recording the number, the time and the location of scanning of the first identification code, and the user information, etc., which are collectively referred to as user scanning information, and matching the user scanning information with the first identification code.

In the step S520, the basic information, the delivery status information, and the user scanning information of the product to the user. Since the first identification code is associated with the basic information, the delivery status information, and the user scanning information of the product, the basic information, the delivery status information, and the user scanning information of the product associated with the first identification code can be provided to the user after the user scans the first identification code.

In addition, since dual layer identification codes are adopted in the embodiment of the present disclosure, the second identification code cannot be acquired directly, but can be acquired after the product is purchased, and a new user may not know the existence of the second identification code. Therefore, when the user sends a query request by scanning the first identification code, prompt information indicating to update the consumed status of the product by scanning the second identification code can be returned to the user.

It should be noted that before the second identification code is scanned, each time the first identification code is scanned, the basic information, the delivery information, and the user scanning information of the corresponding product can be prompted, and the corresponding each query behavior is recorded.

In the step S530, a status update request sent from the user by scanning the second identification code for a first time; the scanning method may be the same as that described in the step S510.

After the step S530, the method further In one embodiment includes a step J520 of recording a number, time, a location, and user information of scanning of the second identification code by the user, which are collectively referred to as user scanning information, and matching the user scanning information with the product.

In the step S540, a delivery status of the product is set to a sold or consumed status.

If the second identification code is scanned for the first time and the second identification code is pre-generated, the delivery status of the product is set to a sold or consumed status;

If the second identification code is scanned again, a result indicating that the second authentication code is unavailable is provided to the user who performs the scanning.

When the second identification code is scanned for the first time and the second identification code is pre-generated, the delivery status of the product is set to the sold or consumed status, so that if a query request sent from a user who is not specially authorized by scanning the first identification code is received again, a sale result of the product is provided to the user. Generally, only when the second identification code is scanned for the first time and the second identification code is pre-generated, the sale status of the product can be changed. If it is prompted that the second identification code is unavailable when the second identification code is scanned, it implies that the second identification code have been scanned, and the corresponding product may have been sold or consumed. The behavior of again scanning the second identification code of the product that has been sold or consumed may be a counterfeiting behavior performed by a counterfeiter using the genuine packaging. A user who is not specially authorized here includes a user who performs second scanning of the second identification code but does not perform first scanning of the second identification code, and a user who performs the second scanning of the second identification code but does not receive an authorization from a user who performs the first scanning of the second identification code or from an authorized user who performs the last scanning of the second identification code. At the same time, it should be noted that when a status update request from an unauthorized user by scanning the second identification code is received, the scanning time, the location, and the user information of the user who performs the scanning of the second identification code are recorded, and the information is matched with the product, so that which product may be counterfeited and in which place or area the product may be counterfeited can be known by inquiring the information of the product and the scanning information of the unauthorized user, to provide the manufacturer, the carrier, and the distributor with a way to track and fight against the counterfeiting.

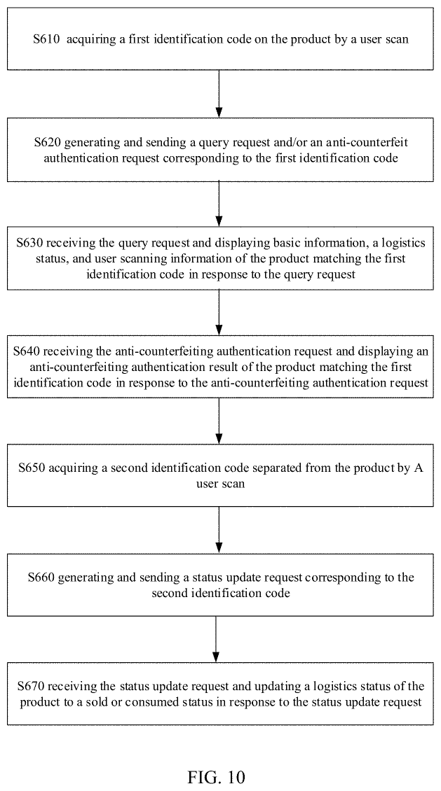

The embodiment of the present disclosure further provides a product traceability and anti-counterfeiting authentication assist method corresponding to the above-mentioned product traceability and anti-counterfeiting authentication method. A flowchart of the assist method is shown in FIG. 10, the method mainly includes the following steps.

S610: a first identification code on a product is acquired by a user scan.

S620: a query request and/or an anti-counterfeiting authentication request corresponding to the first identification code is generated and sent.

S630: basic information, a delivery status, and user scanning information of the product matching the first identification code are received and displayed in response to the query request.

S640: an anti-counterfeiting authentication result of the product matching the first identification code is received and displayed in response to the anti-counterfeiting authentication request.

S650: a second identification code separated from the product is acquired by a user scan.

S660: a status update request corresponding to the second identification code is generated and sent.

S670: the status update request is received and a delivery status of the product is updated to a sold or consumed status in response to the status update request.

In one embodiment, after the step S630, the method further includes: the user is prompted to scan the second identification code within a preset period.

In one embodiment, if the delivery status of the product is updated to the sold or consumed status, the method further includes the following steps:

the product is added to a list of purchased products of the user;

the list of purchased products of the user is displayed;

first identification code user scanning information and second identification code user scanning information of a selected product are displayed in response to a selection of the user;

an operating button is provided and information corresponding to the product is sent to a manufacturer in response to a returning/changing or maintenance service operation of the user;

a store capable of dealing with the corresponding product and a distance from the user to the store are correspondingly displayed in response to the returning/changing or maintenance service operation of the user.

The content of each step will be explained in detail below.

The scanning method described in the step S610 includes, but is not limited to, an existing scanning tool (e.g., WeChat) of an intelligent mobile terminal is used, or a dedicated APP (Application) developed for implementing the method of the present disclosure, hereinafter referred to as an anti-counterfeiting authentication APP, is used.

Since the user can quickly learn and master the APP software installed in the intelligent mobile terminal, the solution of the embodiment of the present disclosure can allow the user to easily and simply query the source of the product without using a special detection tool or mastering special technical knowledge, thereby effectively reducing the query difficulty. In addition, the credibility of the user in the product authentication information is improved by querying via the anti-counterfeiting authentication APP.

In the step S620, a query request and/or an anti-counterfeiting authentication request corresponding to the first identification code are generated and sent. After the first identification code is scanned by using an existing scanning tool (e.g., WeChat) of the intelligent mobile terminal or using a dedicated Application (APP) developed for implementing the method of the present disclosure, the scanning tool (e.g., WeChat) or the dedicated Application (APP) sends a query request corresponding to the first identification code to a merchant server or a third-party server.

In the step S630, the query request is received and basic information, a delivery status, and user scanning information of a product matching the first identification code is displayed in response to the query request. After the merchant server or the third-party server receives the query request, since the merchant server or the third-party server stores the basic information, the delivery status, and the user scanning information of the products matching various first identification codes, the basic information, the delivery status, and the user scanning information of the product matching the first identification code are sent to the user. FIG. 4 shows the basic information, the delivery status information, and the user scanning information of the product received and displayed to the user (the basic information, the delivery status information, and the user scanning information of the provided product are displayed on several pages).

The function of prompting the user to scan the second identification code is provided as follows: since the dual layer identification codes are adopted in the embodiment of the present disclosure, the second identification code cannot be directly acquired, but can be acquired after the product is purchased, and a new user may not know the existence of the second identification code. Therefore, the prompt can assist the user to complete the anti-counterfeiting authentication according to the prompt result. FIG. 4 also shows a prompt content of “Dear customer, if you are interested in purchasing the product, please acquire an anti-counterfeiting label from the merchant to verify the authenticity of the product by scanning the anti-counterfeiting label” which prompts the user to scan the second identification code to obtain the authenticity authentication result of the product. The basic information, the delivery status information, and the user scanning information of the product provided to the user can be displayed in an interface of the anti-counterfeiting authentication APP.

In the step S640, the anti-counterfeiting authentication request is received and an anti-counterfeiting authentication result of the product matching the second identification code is displayed to the user in response to the anti-counterfeiting authentication request. Since the merchant server or the third-party server stores the user scanning information, the anti-counterfeiting authentication result can be sent to the user according to the stored user scanning information.

If the merchant server or the third-party server receives the anti-counterfeiting authentication request sent from the user by scanning the first identification code, and the status of the product is unsold or unconsumed, the anti-counterfeiting authentication result indicating that the product is a genuine product is received and displayed to the user, the prompt interface can be as shown in FIG. 5.

In the step S650, a second identification code on the product is acquired by a user scan. The scanning method can be the same as the scanning method in the step S610.

In the step S660, a status update request corresponding to the second identification code is generated and sent. After the second identification code is scanned by using an existing scanning tool (e.g., WeChat) of the intelligent mobile terminal or using a dedicated Application (APP) developed for implementing the method of the present disclosure, the scanning tool (e.g., WeChat) or the dedicated APP sends a status update request corresponding to the second identification code to the merchant server or the third-party server.

The addition of the product into a list of purchased products of the user functions to facilitate the user to manage the purchased products. The management operation includes, but is not limited to, resale, repair, return/change, and the like. In order to facilitate the user to manage the purchased products, after the step of adding the product to the list of purchased products of the user, the method further includes: the list of purchased products of the user is displayed; the list of purchased products of the user displays basic information of a product purchased by the user and provides an optional operating button; first identification code user scanning information and second identification code user scanning information of a selected product are displayed in response to a selection of the user; the first identification code user scanning information and the second identification code user scanning information are described in detail above and will not be repeated herein; the operating button provided on the interface of the list of purchased products of the user include a returning/changing operation button and a maintenance service operation button, and information of the corresponding product including basic information, delivery status information, and user scanning information of the product are sent to the manufacturer in response to the returning/changing or maintenance service operation of the user, and a store capable of dealing with the corresponding product and a distance from the user to the store are correspondingly displayed in response to the returning/changing or maintenance service operation of the user, to facilitate the user to select a nearby store for a corresponding treatment.

It should be appreciated that the operating button also includes an operation option such as a comment, a lottery, receiving a coupon and/or a red packet, product maintenance knowledge, recommended collocation, and sharing; through the operating button a user can comment on a product, participate in a lottery event, receive a coupon and/or a red packet, learn about the maintenance knowledge of the product, view other products recommended for collocation with the product, and share the product with friends. The multiple operation options provided for the user in this embodiment improve the interaction experience of the user and facilitate the promotion activities of the merchant.

After the second identification code is scanned for the first time, the delivery status of the product is set to the sold status, so that if the second identification code is scanned again and the scanning is not authorized, an anti-counterfeiting authentication result indicating that the product is suspicious is received and displayed to the user, and a corresponding prompt interface can be shown in FIG. 7. Generally, an option to update the status is provided to the user only when the second identification code is scanned for the first time. If the prompt indicates that the second identification code is unavailable when the second identification code is scanned, it implies that the second identification code may have been scanned, and the corresponding product may have been sold or consumed. The behavior of scanning again the second identification code of the product that has been sold or consumed is probably a counterfeiting behavior performed by a counterfeiter with the genuine packaging, in this way, the authenticity of the product can be effectively verified. A user who is not specially authorized here includes a user who performs second scanning of the second identification code but does not perform first scanning of the second identification code, and a user who performs the second scanning of the second identification code but does not receive an authorization from a user who performs the first scanning of the second identification code or from an authorized user who performs the last scanning of the second identification code. At the same time, it should be noted that after the delivery status of the product is updated to be the sold status and when an anti-counterfeiting authentication request sent from an unauthorized user by scanning the first identification code is received, the scanning time, the location, and the user information of the user who performs the scanning on the first identification code are recorded and matched with the product, in this way, which product may be counterfeited and in which place or area the product may be counterfeited can be known by inquiring the information of the product and the scanning information of the unauthorized user, to provide the manufacturer, the carrier, and the distributor with a way to track and fight against the counterfeiting.

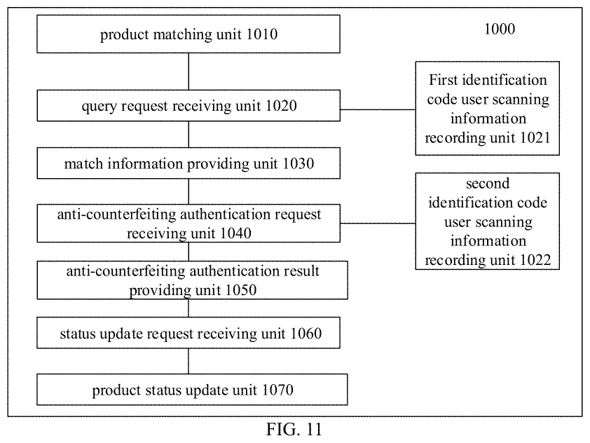

An embodiment of the present disclosure further provides a product traceability and anti-counterfeiting authentication apparatus 1000 corresponding to the product traceability and anti-counterfeiting authentication method. As shown in FIG. 11, which shows a schematic structure diagram of the apparatus. The apparatus 1000 mainly includes the following units.

a query request receiving unit 1020, configured to receive a query request sent from a user by scanning a first identification code;

a matching information providing unit 1030, configured to provide basic information, a delivery status, and user scanning information of the product matching the first identification code to the user;

an anti-counterfeiting authentication request receiving unit 1040, configured to receive an anti-counterfeiting authentication request sent from the user by scanning the first identification code;

an anti-counterfeiting authentication result providing unit 1050, configured to provide an anti-counterfeiting authentication result of the product matching the first identification code to the user;

a status update request receiving unit 1060, configured to receive a status update request sent from the user by scanning a second identification code separated from the product;

a product status update unit 1070, configured to set a delivery status of the product to a sold or consumed status.

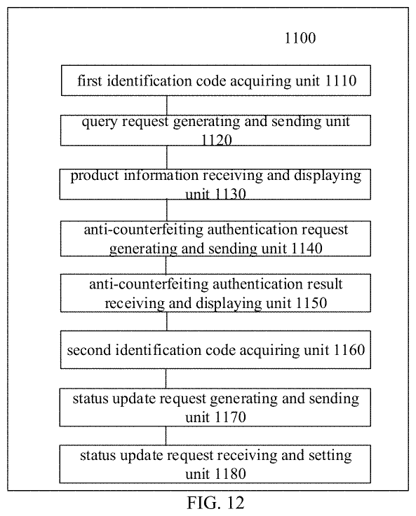

Although other units are further shown in FIG. 12, they are all optional and embodiments of the present disclosure do not depend on these elements.

In one embodiment, the apparatus 1000 further includes a product matching unit 1010 which is configured to:

uniquely match the first identification code with basic information of the specific product;

receive delivery status information of the specific product set by scanning the first identification code, and match the delivery status information with the first identification code;

match the first identification code with authenticity information of the specific product.

In one embodiment, the apparatus 1000 further includes a first identification code user scanning information recording unit 1011 which is configured to record a number, time and a location of scanning of the first identification code by the user, and user information of the user scanning the first identification code, collectively referred to as first identification code user scanning information, after receiving the query request sent from the user by scanning the first identification code, and match the first identification code user scanning information with the first identification code.

In one embodiment, the apparatus 1000 further includes a second identification code user scanning information recording unit 1021 which is configured to record a number, time, a location of scanning of the second identification code by the user, and user information of the user scanning the second identification code, collectively referred to as second identification code user scanning information, after receiving the anti-counterfeiting authentication request sent from the user by scanning the second identification code, and match the second identification code user scanning information with the product.

Alternatively, the product status update unit 1070 is configured to:

set a delivery status of the product to a sold or consumed status;

if the second identification code is scanned for a first time and the second identification code is pre-generated, set the delivery status of the product to the sold or consumed status;

if the second identification code is scanned again, provide a result indicating that the second identification code is unavailable to the user who performs the scanning.

When the second identification code is scanned for the first time and the second identification code is pre-generated, the delivery status of the product is set to the sold or consumed status, so that if a query request sent from a user who is not specifically authorized by scanning the first identification code is received again, a sale result of the product is provided to the user. Generally, only when the second identification code is scanned for the first time and the second identification code is pre-generated, the sale status of the product can be changed. If it is prompted that the second identification code is unavailable when the second identification code is scanned, it implies that the second identification code may have been scanned, and the corresponding product may have been sold or consumed. The behavior of scanning again the second identification code of the product which has been sold or consumed is probably a counterfeiting behavior performed by a counterfeiter with a genuine packaging. A user who is not specially authorized here includes a user who performs second scanning of the second identification code but does not perform first scanning of the first second identification code, and a user who performs the second scanning of the second identification code but does not receive an authorization from the user who performs the first scanning of the second identification code or from an authorized user who performs the last scanning of the second identification code. At the same time, it should be noted that when a status update request sent from an unauthorized user by scanning the second identification code is received, the scanning time, the location, and the user information of the user who scans the second identification code are recorded, and the information is matched with the product, in this way, which product may be counterfeited and in which place or area the product may be counterfeited can be known by inquiring the information of the product and the scanning information of the unauthorized user, to provide the manufacturer, the carrier, and the distributor with a way to track and fight against the counterfeiting.

Alternatively, the dual layer identification codes are any combination of a two-dimensional code, a bar code, a near field communication (NFC) code, and a non-contact radio frequency identification (RFID) code.

An embodiment of the present disclosure further provides a product traceability and anti-counterfeiting authentication assist apparatus 1100 corresponding to the above-mentioned product traceability and anti-counterfeiting authentication apparatus. As shown in FIG. 12, which shows a schematic structure diagram of the apparatus, and the apparatus mainly includes the following units:

a first identification code acquiring unit 1110, configured to acquire a first identification code on the product by a user scan;

a query request generating and sending unit 1120, configured to generate and send a query request corresponding to the first identification code;

a product information receiving and displaying unit 1130, configured to receive the query request and display basic information, a delivery status, and user scanning information of the product matching the first identification code in response to the query request;

an anti-counterfeiting authentication request generating and sending unit 1140, configured to generate and send an anti-counterfeiting authentication request corresponding to the first identification code;

an anti-counterfeiting authentication result receiving and displaying unit 1150, configured to receive the anti-counterfeiting authentication request and display an anti-counterfeiting authentication result of the product matching the first identification code in response to the anti-counterfeiting authentication request;

a second identification code acquiring unit 1160, configured to acquire a second identification code on the product by a user scan;

a status update request generating and sending unit 1170, configured to generate and send a status update request corresponding to the second identification code;

a status update request receiving and setting unit 1180, configured to receive the status update request and update a delivery status of the product to be a sold or consumed status in response to the status update request.

In one embodiment, the apparatus further includes a prompt unit (not shown) configured to prompt the user to scan the second identification code after receiving the query request and displaying basic information, a delivery status, and user scanning information of the product matching the first identification code in response to the query request.

In one embodiment, the apparatus further includes a purchased product displaying unit (not shown) configured to:

add the product to a list of purchased products of the user and display the list of purchased products.

In one embodiment, the apparatus further includes a maintenance and displaying unit (not shown) configured to:

display the list of purchased products of the user;

display first identification code user scanning information and second identification code user scanning information of a selected product in response to a user selection;

provide an operating button and send information corresponding to the product to a manufacturer in response to a returning/changing or maintenance service operation of the user.

In one embodiment, the maintenance and displaying unit is further configured to display a store capable of dealing with the corresponding product and a distance from the user to the store in response to the returning/changing or maintenance service operation of the user.

It should be appreciated that the operating button also include an operation option such as a comment, a lottery, receiving a coupon and/or a red packet, product maintenance knowledge, recommended collocation, and sharing, through which a user can comment on a product, participate in a lottery event, receive a coupon and/or a red packet, learn about the maintenance knowledge of the product, view other products recommended for collocation with the product, and share the product with friends. The multiple operation options provided for the user in the embodiment improve the interaction experience of the user and facilitate the promotion activities of the merchant.

From the above, in an embodiment of the present disclosure, the present disclosure adopts the dual layer identification codes including the first identification code and the second identification code, since there is no matching relationship between the first identification code and the second identification code, the counterfeiter cannot acquire the first identification codes and the second identification codes of an entire batch of similar products by analyzing the first identification code and the second identification code of one product, thereby improving the anti-counterfeiting efficiency. Moreover, the second identification code is provided to the consumer by the seller after the product is purchased, so that the counterfeiter can only acquire the second identification code after purchasing a genuine product, thereby increasing the counterfeiting cost. In addition, in the present disclosure, the delivery status of the product is updated by recording the number of scanning of the second identification code, so that a prompt indicating that the product is suspicious is obtained when an unauthorized user scans the second identification code again, thereby substantially blocking a possibility of reperfusion using the genuine product package by the counterfeiter to manufacture a counterfeit product and successfully sell the counterfeit product; and the record of another unauthorized scanning activity on the second identification code can also facilitate the manufacturers, carriers, and distributors to track and fight against potential counterfeiting activities. In addition, the mode in which the dual layer identification codes uniquely match the basic information, the delivery status information, the user scanning information, and the authenticity information of the product also provides a guarantee for tracking and tracing the product, product anti-channel conflict, and checking the authenticity according to the delivery information of the product. In the anti-counterfeiting method and apparatus provided by the present disclosure, an anti-counterfeiting authentication query can be implemented by a simple operation of scanning the dual layer identification codes. According to the above characteristics, the product having the dual layer identification codes and the anti-counterfeiting method and apparatus provided by the present disclosure greatly improve the anti-counterfeiting effect.

It should be noted that the present disclosure may be implemented in software and/or a combination of software and hardware, e.g., may be implemented using an application specific integrated circuit (ASIC), a general purpose computer, or any other similar hardware apparatuses. In an embodiment, the software program of the present disclosure can be executed by a processor to implement the steps or functions described above. Similarly, the software programs of the present disclosure, including associated data structures, can be stored in a computer-readable recording medium, such as, for example, a RAM storage, a magnetic or optical drive, or a floppy disk, and the like. In addition, some of the steps or functions of the present disclosure can be implemented in hardware, for example, as circuitry that cooperates with a processor to perform various steps or functions.

In addition, part of the present disclosure can be applied as a computer program product, such as a computer program instruction, which, when executed by a computer, can call or provide a method and/or solution of the present disclosure by an operation of the computer. The program instruction calling the method of the present disclosure can be stored in a fixed or removable recording medium, and/or can be sent through a data stream in a broadcast or other signal carrying media, and/or can be stored in a working memory of a computer device running according to the program instruction. Here, an embodiment according to the present disclosure provides an apparatus including a memory for storing a computer program instruction and a processor for executing the program instruction, when the computer program instruction is executed by the processor, the apparatus is triggered to execute a method and/or a solution based on the foregoing embodiments of the present disclosure.

Embodiments of the present disclosure are not limited to the details of the exemplary embodiments described above, and that the present disclosure can be implemented in other specific forms without departing from the spirit or essential characteristics of the present disclosure. Accordingly, the examples are considered in all respects as exemplary and non-limiting, the scope of the present disclosure is defined by the appended claims rather than the foregoing description, and all changes that fall within the meaning and range of equivalency of the claims are therefore included in the present disclosure. Any reference signs in the claims shall not be construed as limiting the claims to which they relate. Also, it is obvious that the word “including” does not exclude other units or steps, and the singular does not exclude the plural. The plurality of units or apparatuses recited in the system claims can also be implemented by one unit or apparatus by means of software or hardware. The first, second, and the like are used for denoting names rather than any particular order.

1. A product having dual layer identification codes, the dual layer identification codes comprising a first identification code attached to the product and a second identification code separated from the product;
wherein the second identification code is provided to a user when the product is sold to the user.

2. The product according to claim 1, wherein the first identification code of the dual layer identification codes matches a plurality of second identification codes.

3. The product according to claim 1, wherein the first identification code and the second identification code match a same type of product.

4. The product according to claim 1, wherein there is no matching relationship between the first identification code and the second identification code of the dual layer identification codes.

5. The product according to claim 1, wherein the second identification code is not associated with a product or a product category.

6. The product according to claim 1, wherein the dual layer identification codes are any combination of a two-dimensional code, a bar code, a near field communication (NFC) code, and a non-contact radio frequency identification (RFID) code.

7. A product traceability and anti-counterfeiting authentication method, applied to the product according to claim 1, comprising:
receiving a query request sent from a user by scanning the first identification code on the product;
providing basic information, a delivery status, and user scanning information of the product matching the first identification code to the user, wherein the first identification code is attached to the product;
receiving an anti-counterfeiting authentication request sent from a user by scanning the second identification code, wherein the second identification code is separated from the product;
determining whether a time interval between the receiving the query request and the receiving the anti-counterfeiting authentication request satisfies a preset threshold value; and
providing an anti-counterfeiting authentication result of the product matching the second identification code to the user if the time interval between the receiving the query request and the receiving the anti-counterfeiting authentication request satisfies the preset threshold value.

8. The method according to claim 7, further comprising pre-generating the dual layer identification codes matching a specific product, wherein the pre-generating the dual layer identification codes matching the specific product specifically comprises:
generating the first identification code and the second identification code respectively according to a standard method;
matching the first identification code with a plurality of second identification codes to obtain a plurality of dual layer identification codes; and
uniquely matching the plurality of dual layer identification codes with the specific product.

9. The method according to claim 7, further comprising: uniquely matching the first identification code with the specific product;
wherein the uniquely matching the first identification code with the specific product comprises:
uniquely matching the first identification code with basic information of the specific product;
receiving delivery status information of the specific product set by scanning the first identification code, and matching the delivery status information with the first identification code; and
matching the second identification code with authenticity information of the specific product.

10. The method according to claim 7, further comprising:
after the receiving the query request sent from the user by scanning the first identification code,
recording a number, time and a location of scanning of the first identification code, and user information of the user scanning the first identification code, collectively referred to as first identification code user scanning information, and matching the first identification code user scanning information with the first identification code.

11. The method according to claim 7, further comprising:
after the receiving the anti-counterfeiting authentication request sent from the user by scanning the second identification code,
recording a number, time, a location of scanning of the second identification code, and user information of the user scanning the second identification code, collectively referred to as second identification code user scanning information, and matching the second identification code user scanning information with the product.

12. The method according to claim 7, wherein the providing the anti-counterfeiting authentication result of the product to the user comprises:
if the second identification code is scanned for a first time and the second identification code is a pre-generated second identification code corresponding to the first identification code, providing an anti-counterfeiting authentication result indicating that the product is a genuine product to the user who scans the second identification code for the first time, and set the delivery status of the product to a sold or consumed status;
if the second identification code is scanned for a second time and a user who scans the second identification code for the second time is not specially authorized, providing an anti-counterfeiting authentication result indicating that the product is suspicious to the user who scans the second identification code for the second time; and
if the second identification code is not a pre-generated second identification code corresponding to the first identification code, providing an anti-counterfeiting authentication result indicating that the second identification code is not provided by a manufacturer or a designated authorized distributor of the product or that the product is suspicious to a user who scans the second identification code.

13. A product traceability and anti-counterfeiting authentication method, applied to the product according to claim 1, comprising:
receiving a query request and/or an anti-counterfeiting authentication request sent from a user by scanning the first identification code on the product;
providing basic information, a delivery status, and user scanning information and/or an anti-counterfeiting authentication result of the product matching the first identification code to the user, wherein the first identification code is attached to the product;
receiving a status update request sent from a user by scanning the second identification code, wherein the second identification code is separated from the product; and
setting the delivery status of the product to a sold or consumed status.

14. The method according to claim 13, further comprising uniquely matching the first identification code with a specific product, wherein the uniquely matching the first identification code to with the specific product specifically comprises:
uniquely matching the first identification code with basic information of the specific product;
receiving delivery status information of the specific product set by scanning the first identification code, and matching the delivery status information with the first identification code; and
matching the first identification code with authenticity information of the specific product.

15. The method according to claim 13, further comprising:
after the receiving the query request sent from the user by scanning the first identification code,
recording a number, time, a location of scanning of the first identification code, and user information of the user scanning the first identification code, collectively referred to as first identification code user scanning information, and matching the first identification code user scanning information with the first identification code.

16. The method according to claim 13, further comprising: updating a status of the product to be a sold status;
wherein the updating the status of the product to be the sold status comprises:
if the second identification code is scanned for a first time and the second identification code is pre-generated, setting the delivery status of the product to a sold or consumed status; and
if the second identification code is scanned for a second time, providing a result indicating that the second identification code is unavailable to a user who scans the second identification code for the second time.

17. The method according to claim 7 or 13, wherein the dual layer identification codes are any combination of a two-dimensional code, a bar code, a near field communication (NFC) code, and a non-contact radio frequency identification (RFID) code.

18-28. (canceled)

29. A product traceability and anti-counterfeiting authentication assist method, applied to the product according to claim 1, comprising:
acquiring the first identification code on the product by a user scan;
generating and sending a query request corresponding to the first identification code;
receiving the query request and displaying basic information, a delivery status, and user scanning information of the product matching the first identification code in response to the query request;
acquiring a second identification code separated from the product by a user scan;
generating and sending an anti-counterfeiting authentication request corresponding to the second identification code; and
receiving the anti-counterfeiting authentication request and displaying an anti-counterfeiting authentication result of the product matching the second identification code in response to the anti-counterfeiting authentication request.

30. A product traceability and anti-counterfeiting authentication assist method, comprising:
acquiring a first identification code on a product by a user scan;
generating and sending a query request and/or an anti-counterfeiting authentication request corresponding to the first identification code;
receiving the query request and displaying basic information, a delivery status, and user scanning information of the product matching the first identification code in response to the query request;
receiving the anti-counterfeiting authentication request and displaying an anti-counterfeiting authentication result of the product matching the first identification code in response to the anti-counterfeiting authentication request;
acquiring a second identification code separated from the product by a user scan wherein the second identification code is provided to a user when the product is sold to the user;
generating and sending a status update request corresponding to the second identification code; and
receiving the status update request and updating a delivery status of the product to a sold or consumed status in response to the status update request.

31. The method according to claim 30, further comprising:
after the receiving the query request and displaying the basic information, the delivery status, and the user scanning information of the product matching the first identification code in response to the query request,
prompting the user to scan the second identification code within a preset period;
further comprising: adding the product into a list of purchased products of the user if the anti-counterfeiting authentication result indicates that the product is genuine;
further comprising:
after the adding the product to the purchased list of the user,
displaying the list of purchased products of the user;
displaying first identification code user scanning information and second identification code user scanning information of a selected product in response to a user selection; and
providing an operating button and sending information of a corresponding product to a manufacturer in response to a returning/changing or a maintenance service operation of a user;
further comprising: displaying a store capable of dealing with the corresponding product and a distance from the user to the store in response to the returning/changing or maintenance service operation of the user.

32-40. (canceled)
